(19) United States
(12) Patent Application Publication
(10) Pub. No.: US 2012/0199150 A1
(43) Pub. Date: Aug. 9, 2012

(54) Apparatus And Method For Attaching And/Or Repairing Fake Nails

(76) Inventor: Minh Le, Lake Worth, FL (US)

(21) Appl. No.: 13/023,734

(22) Filed: Feb. 9, 2011

(51) Int. Cl. A45D 29/14; B23B 35/00

(52) U.S. Cl. 132/75.8; 408/1 R

(57) ABSTRACT

A flexible sharp drill system with a single common drill controller, and a single foot speed controller. Each flexible sharp is associated with its own drill, thereby eliminating the need to change the flexible sharps. A common drill controller uses sensors to determine when a particular flexible sharp has been selected. When the selected flexible sharp has been identified by the sensor, the controller automatically turns the selected flexible sharp drill on and turns all other drills off. In addition, the single foot speed controller is automatically switched to control the selected flexible sharp.

### BACKGROUND OF THE INVENTION

1. Technical Field

The present invention relates to drill machines with flexible sharps for use in the installation and repair of fake nails. In particular, it relates to a drill machine system having multiple sensor activated drills with each drill associated with a particular flexible sharp. A common controller controls each of the sensor activated drills along with a shared foot speed controller.

2. Background

A variety of cosmetic treatments have been developed to enhance the appearance of an individual's nails. Initially, a variety of polishes were developed to coat the surface of the nail to enhance their appearance. In addition, liquid formulations have been made to repair cracks or regularities in a nail which can then be polished to restore the nail to an appropriate appearance.

Later, another type of nail treatment was developed which provided fake nails that are attached to the original underlying nail. Fake nails are particularly useful in that they can be constructed from material which is highly durable, and which provides a uniform appearance for all the fingers on an individual's hands.

Initially, fake nails were attached with hand tools which required a substantial amount of effort on the part of the technician when working with an individual's nails. As a result, their cost was quite high. To improve efficiency, power driven drills began to be used with flexible sharps. The power driven flexible sharps greatly reduced the work required on the part of technician. However, the installation of fake nails generally requires many types of flexible sharps. The reason for this is that flexible sharps are used to clean, cart, grind, and finish the fake nails. Each one of these operations may take one or more different flexible sharps. For example, a technician may use approximately 6 different types of sharps on a single individual's nails as the various steps are taken during the installation and/or repair process. As the technician moves from one step of the process to another, the flexible sharp must be removed and replaced with the flexible sharp that is currently needed. As a result, the constant switching of flexible sharps on a drill will result in a substantial amount of time consumption and extra work on the part of the technician. Of course, the extra time required will eventually result in reduced efficiency and increased cost.

In addition to the time costs associated with switching a flexible sharp there are other disadvantages with the prior art. For example, in the situation where a single drill is used, the flexible sharps will be constantly switched during the course of the day, and the extra wear and tear created by this process will quickly shorten the useful life of the flexible sharp. This single drill configuration typically uses a single foot speed controller.

An alternative method uses two or more drill machines, each having their own foot controller. This configuration reduces the number of flexible sharp changes. However, it creates a new problem in that the technician has several foot controllers on the floor which makes it more complicated to control the drills.

Another alternative approach has been to use two to four flexible sharp drills with a common controller. This method further reduces the need to change flexible sharp drill bits, but the technician now has to manually switch from one drill to another while preparing or installing fake nails. In practice, a technician will need approximately six different flexible sharp drill bits to complete a job. However, six machines would be cumbersome and difficult to work with. As a result, most nail facilities use only a maximum of three flexible sharp drills.

While these various prior art devices accomplish their intended purposes, they also provide a substantial amount of additional work for the technician due to either the constant adjustment and replacement of flexible sharps during the course of a single nail installation, or the additional work associated with multiple foot controllers, and/or multiple manual switching operations to convert from one drill to another. Because there is a constant need for different sharps during the installation/repair process, the actual benefit provided to the technician by prior art drill systems is minimized.

### SUMMARY OF THE INVENTION

The present invention provides a flexible sharp drill system with a single common drill controller, and a single foot speed controller. Each of the flexible sharps used during an installation/repair procedure are associated with and secured to their own drill, thereby eliminating the need to change the flexible sharps. Sensors, communicating with the common drill controller, are used to determine when a particular flexible sharp has been selected. When the selected flexible sharp is identified by the sensor, the controller automatically turns the selected flexible sharp drill on and turns all other drills off. In addition, the single foot speed controller is automatically switched to control the selected flexible sharp.

### BRIEF DESCRIPTION OF THE DRAWINGS

FIG. 1 is an illustration of a preferred embodiment of the invention showing multiple flexible sharp drills controlled by a single common drill controller and a single foot speed controller.

FIG. 2 is an illustration of a preferred embodiment of a flexible sharp and handle.

FIGS. 3A-F are side views of handles in combination with a variety of flexible sharps.

FIG. 4 illustrates a preferred embodiment of sensors 6 suspending four drills 2 from a support bar.

FIG. 5 illustrates an alternative preferred embodiment in which the sensor is replaced with a switch in the handle.

FIG. 6 illustrates an alternative preferred embodiment in which the sensor is a magnetic or RFID switch in the handle.

FIG. 7 illustrates an alternative preferred embodiment in which the sensor is replaced with a switch in the handle, and the drills are integrated with the common drill controller.

### DESCRIPTION OF THE PREFERRED EMBODIMENT

Prior to a detailed discussion of the figures, a general overview of the invention will be presented. The invention provides a fake nail installation/repair system. The fake nail installation/repair system is intended to be used by the technician to control multiple flexible sharp drills without having to change flexible sharps, to automatically switch a foot speed controller from one flexible sharp to another, and to automatically switch control of flexible sharps during the course of an installation or repair.

The device further includes a single common drill controller which is operatively connected to, and controls, all the drills that are attached to it. Sensors are used to determine when the drill has been selected. The sensors then inform the common drill controller that a particular flexible sharp is selected. In turn, the controller will automatically deactivate all other drills and activate the selected flexible sharp drill. In addition, the foot speed controller which is attached to the common drill controller is automatically switched to control the newly selected flexible sharp drill.

An advantage of using the sensor system is that it eliminates the need for any manual switching by the technician, thereby saving time. Eliminating manual switching greatly simplifies the technicians work and avoids mistakes. By automatically turning off drills which are not being used, safety is also improved. Another improvement over the prior art is the manner in which the foot speed controller is managed. The foot speed controller is attached to a common controller. The drills are also attached to the common controller. When a drill picked up by the technician, it is detected by sensors attached to the common controller. When the common controller determines that a particular dril is selected, it automatically turns off the other drills, and automatically switches the foot speed controller to the selected drill. This eliminates the need for multiple foot speed controllers, and eliminates the need for any action on the part of the technician when switching drills.

The invention provides the technician with an extremely simple to use system which requires no changing of flexible sharps. As a result, the technician can more rapidly complete the task of installing or repairing fake nails. In addition, the controller provides switching mechanism such that a single foot speed controller can be used to control any drill which is selected. This also reduces costs and provides convenience to the technician. Further, automatic activation of only the selected flexible sharp improves safety by ensuring that all other drills are turned off. The invention provides a flexible sharp system for the technician that allows the technician to concentrate on work to be done rather than the overhead tasks of manually operating and manipulating switches, working multiple foot speed controllers, and changing flexible sharp drill bits.

Another advantage provided by the invention is that it provides substantial time savings which increase the productivity of the technician, and the profitability of the technician's employer. Further, the customer is also provided with an advantage in that they are able to get in and out of the establishment in a minimum amount of time.

Having discussed the features and advantages of the invention in general, we turn now to a more detailed discussion of the figures.

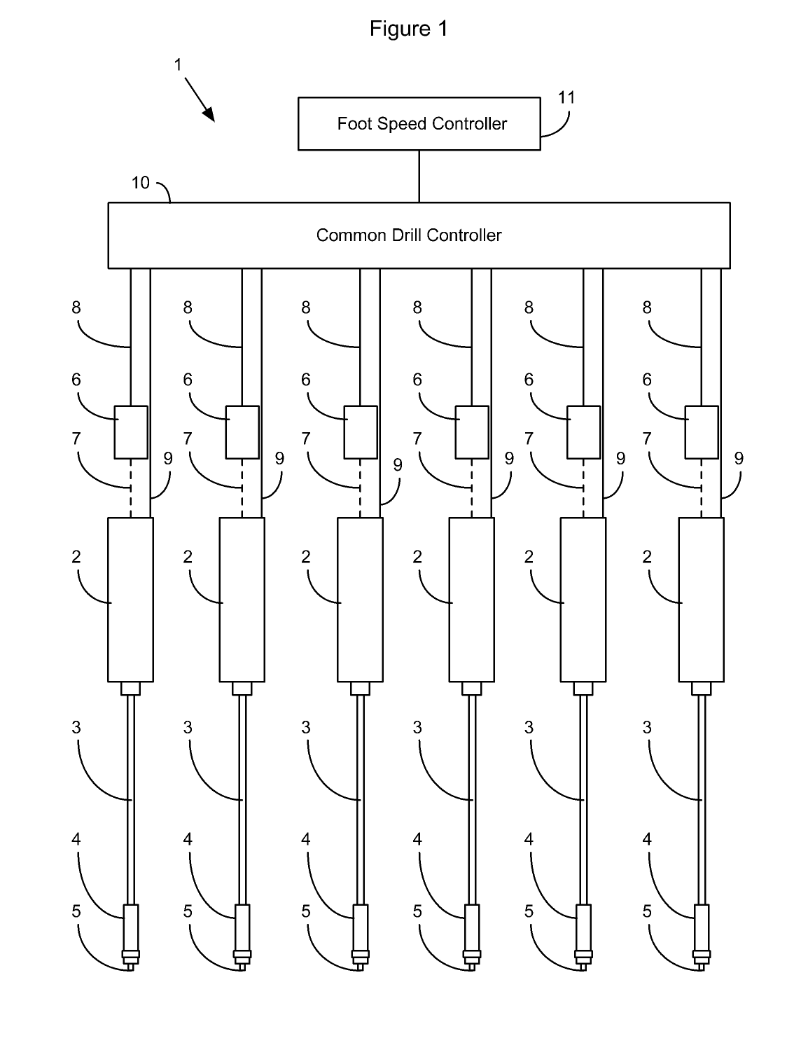

In FIG. 1, a preferred embodiment of the flexible sharp drill system 1 is shown. This figure shows the common drill controller 10 attached to the foot speed controller 11. Also attached to the common drill controller 10 are a series of flexible sharp drill assemblies. Each flexible sharp drill assembly includes a power drill 2, which is designed to provide power to the flexible sharp 5 under control of the common drill controller 10. Each flexible sharp 5 is secured to a handle 4 which is held by the technician during use. The flexible sharp 5 is driven by the power drill 2 via cable 3. A sensor 6 is associated with each power drill 2. Line 7 is shown as a broken line to indicate that there are multiple ways in which the sensor can determine when the particular power drill 2 has been selected. For example, the power drill 2 can be suspended via a spring-loaded, or gravity based, hook mechanism from the sensor 6 so that when the technician selects a particular drill assembly by moving the power drill 2 off of the hook, the sensor 6 can detect it. The sensor 6 would then notify the common drill controller 10 via control line 8 that a particular flexible sharp drill assembly has been selected. At this point, all other drill motors 2 are turned off, and the selected drill motor 2 is turned on.

Those skilled in the art will recognize that how the sensor 6 detects the selection of a particular flexible sharp drill assembly can vary. For example, it can be based on a spring-loaded or gravity mechanism as discussed above, it can be based on a magnetic switch, it can be based on any motion sensing technology which would detect removal of the power drill 2, it can use RFID technology, etc. For the purposes of the invention, any suitable technology can be used to detect when the drill motor 2 is selected. Likewise, the sensor 6 can be incorporated into the handle 4 such that when the technician grasps the handle 4 it can be detected via motion sensing, infrared, a manual switch, etc. Once detected, the sensor 6 would notify the common drill controller 10 via a control line in cable 3, or any other suitable technology such as RF, etc.

Once the common drill controller 10 determines that a particular flexible sharp 5 has been selected, it activates that flexible sharp while the other flexible sharp drill assemblies are turned off. This provides a safety benefit, and also a performance benefit since the technician does not need to take any action to switch flexible sharps 5. Since multiple flexible sharp drill assemblies are provided, each flexible sharp 5 which might be used by the technician is already attached to a power drill 2. As a result, the technician does not have to waste any time changing flexible sharps 5. Common drill controller 10 can be implemented by any suitable technology, such as hardwired circuitry, or as a programmable control unit. The only requirement is that it provides an effective interface between the foot speed controller 11 and the drill assemblies.

Another advantage provided by the invention is that only a single foot speed controller 11 is required. Typically, prior art systems are merely conglomerations of independent flexible sharp drill assemblies, each requiring their own foot speed controller 11. By integrating all of the flexible sharp drill assemblies into a single system with a common drill controller 10, a single foot speed controller 11 can be used by the technician. This results in cost savings and more convenience for the technician since they do not have to be concerned with which foot speed controller 11 should be used with a particular flexible sharp.

For ease of illustration, the power source used by flexible sharp drill system 1 is not shown in this figure. The power source in the preferred embodiment is a conventional power plug that is inserted into a wall outlet. It can be attached to the system at any convenient point, such as the common drill controller 10, the foot speed controller 11, etc. Conventional power sources of this type are well-known in the art and do not need further discussion herein.

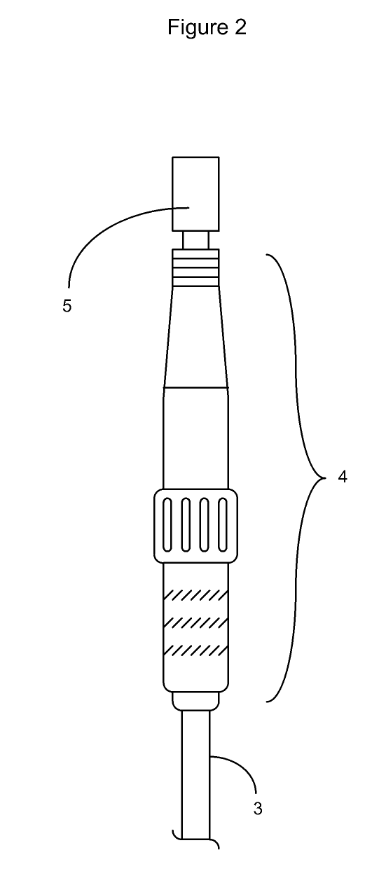

FIG. 2 illustrates a side view of a preferred embodiment of the flexible sharp 5 and a handle 4. Flexible sharps 5 and handles 4 are well known in the art and are commercially available from a variety of sources.

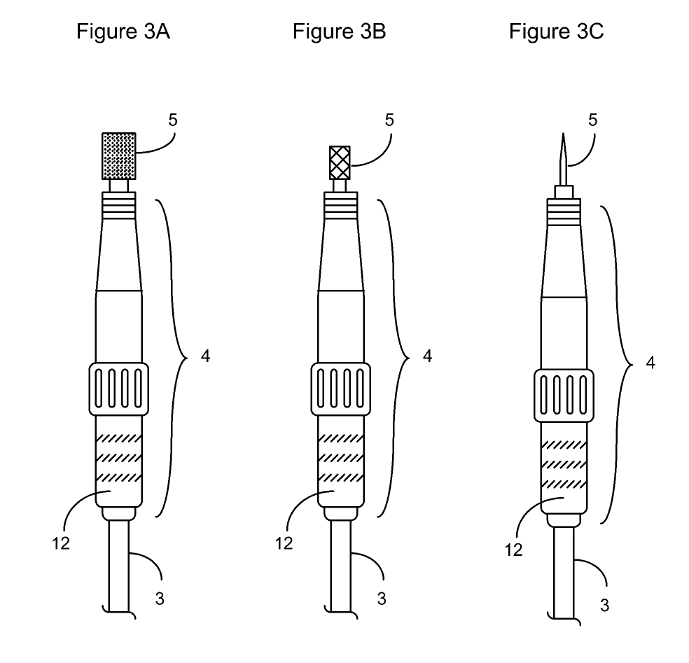

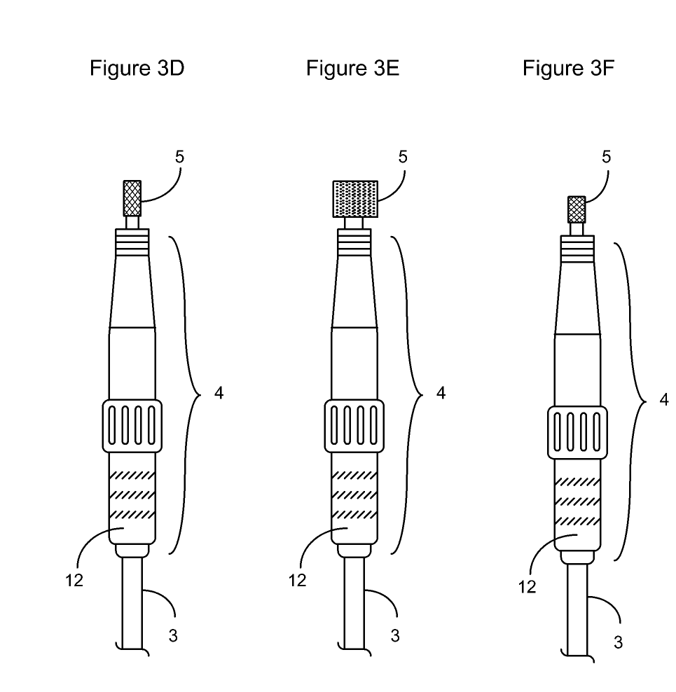

FIG. 3A-F show side views of handles 4 in combination with a variety of flexible sharps 5. During normal use, the technician would merely grasp the desired handle/sharp combination 4-5 and begin to work. Also shown in these figures are optional color-coded sections 12 on handles 4. By color coding portions of the handles 4, the technician may more easily select and grasp the correct handle 4.

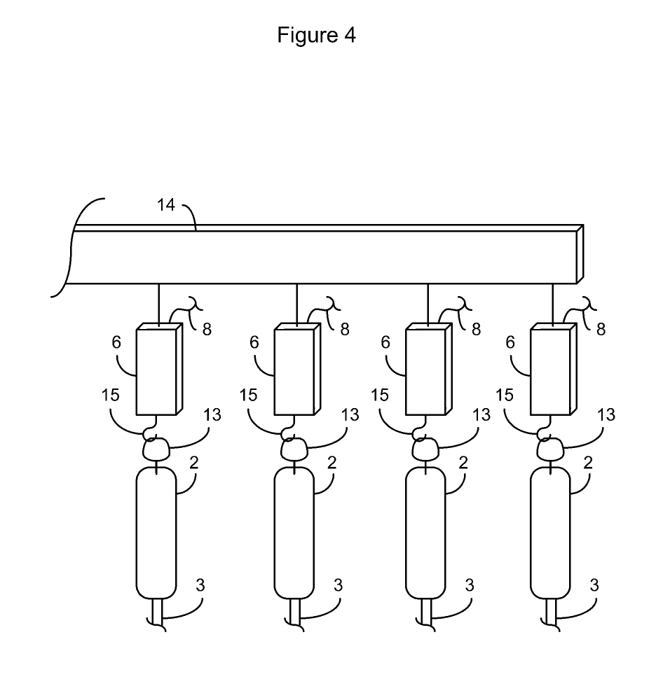

FIG. 4 illustrates some of the sensors 6 suspended from a support bar 14. In this figure, line 7 of FIG. 1 has been replaced with spring-loaded hook 15. When a flexible sharp 5 is not in use, the power drill 6 is suspended from spring-loaded hook 15 via attachment loop 13. The weight of the power drill 6 pulls the hook 15 away from the sensor 6. This disengages a switch inside sensor 6 and turns off power drill 2. When a flexible sharp 5 is selected, power drill 2 is unhooked from spring-loaded hook 15. This causes a spring-loaded hook 15 to retract towards sensor 6, which in turn activates a switch inside of sensor 6. When the switch is activated, the common drill controller 10 knows that the associated flexible sharp 5 has been selected. At this point, the foot speed controller 11 is switched to that flexible sharp 5 and the flexible sharp 5 is ready for use without any other action by the technician. Preferably, and for safety reasons, power is only applied to the selected flexible sharp 5 by its associated power drill 2 when the technician presses down on the foot speed controller 11.

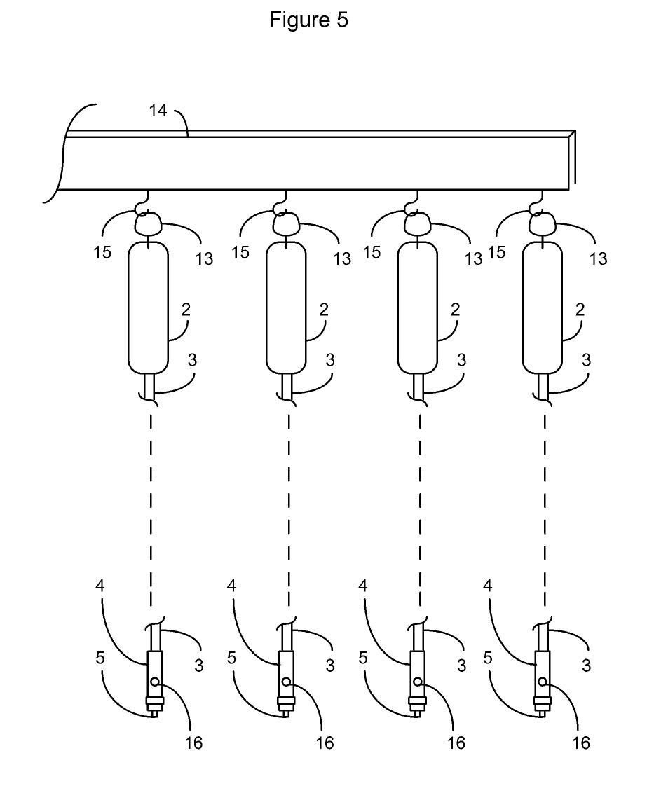

FIG. 5 illustrates an alternative preferred embodiment in which the sensor 6 is discarded and replaced with a switch 16. In this embodiment, power drill 2 is permanently attached to a support bar 14. In use, the technician merely selects the handle 14 for the appropriate flexible sharp 5. The technician then selects switch 16 which notifies the common drill controller 10 that the flexible sharp 5 has been selected. The common drill controller 10 automatically turns off all other power drills 2, and switches the foot speed controller 11 such that it now controls the speed of the selected flexible sharp 5. Switch 16 can communicate with common drill controller 10 via a control line running through cable 3 or by any other acceptable means, such as RF transmission. Likewise, power to the flexible sharp 5 can be terminated by removing the technician's foot from the foot speed controller 11, by manually switching power off, automatically turning off power based on inactivity, and/or any other suitable means such as sensing the position of the flexible sharp (e.g. hanging vertically, etc.).

As can be seen, the common drill controller 10 and shared foot speed controller 11 provides convenience to the technician, increases the technician's efficiency, reduces cost to the business and increases profitability of the business.

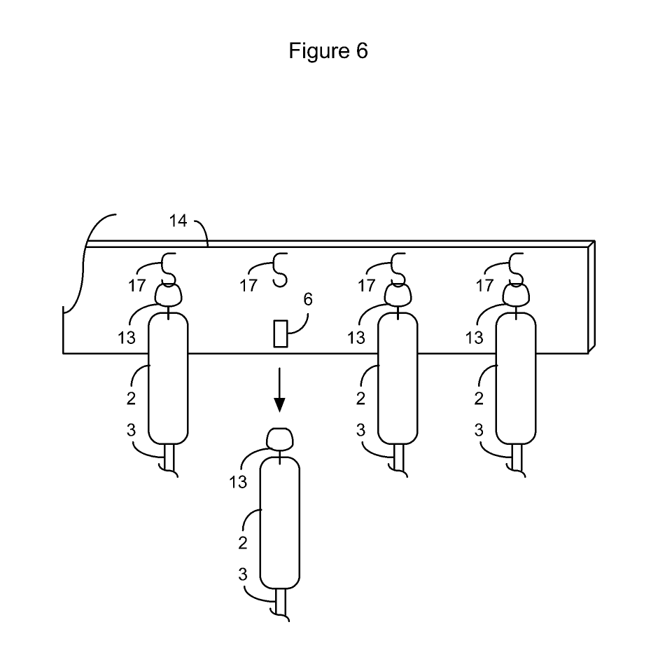

In FIG. 6, another alternative embodiment is shown. In this embodiment the sensor 6 is a magnetic or RFID device which is suspended from hook 16. When the technician selects drill 2 by lifting it from hook 16, the sensor 6 detects the movement and automatically switches on that drill 2 and shuts off power to the other drills 2. This embodiment illustrates a particular method of sensing which drill 2 is selected. However, those skilled in the art will recognize that any suitable sensing technology can be used in its place.

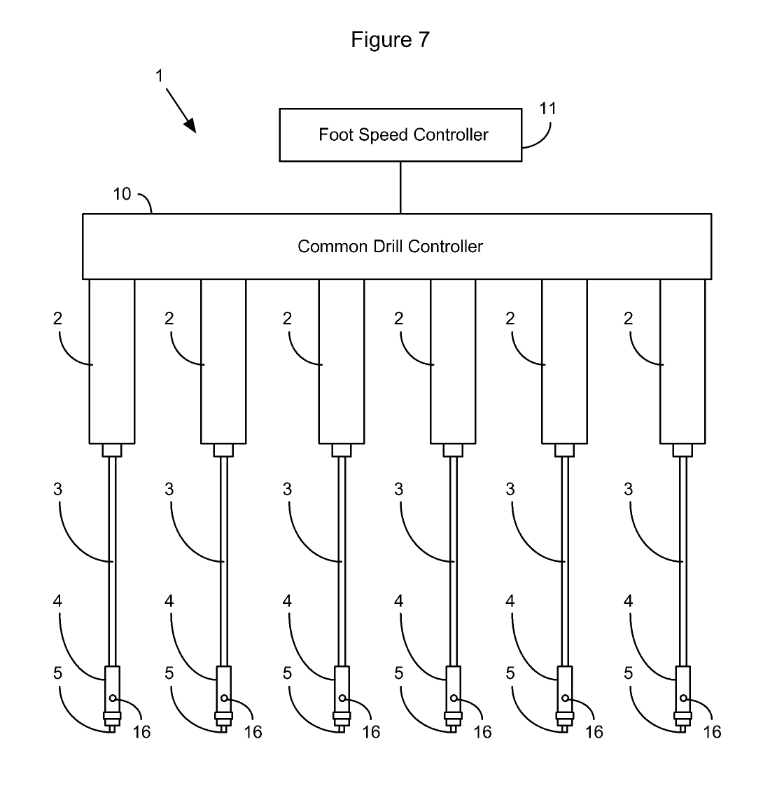

FIG. 7 illustrates another preferred embodiment in which the drills 2 are integrated into the common drill controller. In this embodiment, the sensing device is eliminated and switch 16 is shown on each of the handles 4. For ease of illustration, the switch 16 is shown as a manual switch, but it can also be implemented as an automatic switch that activates based on predetermined factors, such as motion, position, etc. This embodiment also has the drills 2 integrated with the common drill controller 10.

It is preferred that for safety reasons, the common controller 10 would cut off power to all of the drills 2 when more than one drill 2 has been selected. In such an event, the common drill controller 10 would alert the technician to this condition via an appropriate alarm, for example, an audible alarm such as a buzzer, or a visual indicator such as an LED lamp.

While the invention has been described with respect to a preferred embodiment thereof, it will be understood by those skilled in the art that various changes in detail may be made therein without departing from the spirit, scope, and teaching of the invention. For example, the material used to construct a system may be anything suitable for its purpose, the size and shape of a system can vary, the type of circuitry and sensing devices can vary, etc. Accordingly, the invention herein disclosed is to be limited only as specified in the following claims.

What is claimed is:

1. A method of automatically activating and controlling powered flexible sharps, including the steps of:
automatically sensing when one of a plurality of flexible sharps is selected;
automatically providing power to the selected flexible sharp;
automatically switching control of the selected flexible sharp to a shared foot speed controller; and
controlling the speed of the flexible sharp by operation of the shared foot speed controller.

2. A method, as the claim 1, including the additional step of:
automatically disabling the flexible sharps which have not been selected.

3. A method, as in claim 2, including the additional step of:
using gravity based sensors to detect when a flexible sharp has been selected.

4. A method, as in claim 2, including the additional step of:
using magnetic or RFID sensors to detect when a flexible sharp has been selected.

5. A method, as in claim 1, including the additional step of:
selecting a flexible sharp by activating a switch in the flexible sharp drill assembly.

6. A method, as in claim 3, including the additional step of:
color coding each flexible sharp to visually distinguish each flexible sharp from one another.

7. A method, as in claim 4, including the additional step of:
color coding each flexible sharp to visually distinguish each flexible sharp from one another.

8. A method, as in claim 1, including the additional step of:
using a common controller to provide an interface between the foot speed controller and the plurality of flexible sharps, to detect the selection of a flexible sharp, and to operatively connect the selected flexible sharp to the foot speed controller.

9. A nail installation/repair system, comprising:
a common drill controller;
a foot speed controller operatively attached to the common drill controller;
a plurality of flexible sharp drill assemblies operatively attached to the common drill controller;
sensing means to automatically detect when a flexible sharp is selected;
means in the common controller to automatically interface the foot speed controller with the selected flexible sharp drill assembly;
whereby a single foot speed controller is automatically switched to control a flexible sharp drill assembly that is selected from a plurality of flexible sharp drill assemblies.

10. A system, as in claim 9, wherein:
the sensing means are spring loaded gravity based switches, with at least one spring loaded gravity based switch associated with each flexible sharp drill assembly.

11. A system, as in claim 9, wherein:
the sensing means are magnetic switches, with at least one magnetic switch associated with each flexible sharp drill assembly.

12. A system, as in claim 9, wherein:
the sensing means are RFID switches, with at least one RFID switch associated with each flexible sharp drill assembly.

13. A system, as in claim 9, wherein:
each of the flexible sharp drill assemblies are color coded to distinguish them from one another.

14. A device, as in claim 9, wherein each of the flexible sharp drill assemblies further comprise:
a handle;
a switch in the handle for activating the flexible sharp drill assembly.

15. A nail installation/repair system, comprising:
a common drill controller;
a foot speed controller operatively attached to the common drill controller;
a plurality of flexible sharp drill assemblies operatively attached to the common drill controller;
means to select a flexible sharp drill assembly from the plurality of flexible sharp drill assemblies;
means in the common controller to automatically give the foot speed controller control over the selected flexible sharp drill assembly;
whereby a single foot speed controller is switched to control a flexible sharp drill assembly that is selected from a plurality of flexible sharp drill assemblies.

16. A device, as in claim 15, wherein:
each flexible sharp drill assembly further comprises a handle and a switch;
activation of the switch is detected by the common drill controller which then selects its flexible sharp drill assembly, and
the foot speed controller is operatively attached to the selected flexible sharp drill assembly.

17. A device, as in claim 15, wherein:
the means to select a flexible sharp drill assembly is a sensor that automatically detects when a flexible sharp drill assembly is selected.

18. A device, as in claim 17, wherein:
the sensor is a spring loaded gravity switch.

19. A device, as in claim 17, wherein:
the sensor is a magnetic switch.

20. A device, as in claim 17, wherein:
the flexible sharp drill assemblies are color coded for rapid identification.
